(19) United States
(12) Patent Application Publication
(10) Pub. No.: US 2013/0169833 A1
(43) Pub. Date: Jul. 4, 2013

(54) IMAGE SENSING APPARATUS

(71) Applicant: Sanyo Electric Co., Ltd., Osaka (JP)

(72) Inventor: Minoru Omori, Osaka (JP)

(73) Assignee: SANYO ELECTRIC CO., LTD., Osaka (JP)

(21) Appl. No.: 13/709,702

(22) Filed: Dec. 10, 2012

(30) Foreign Application Priority Data
Dec. 28, 2011 (JP) 2011-288128

(51) Int. Cl. H04N 5/232

(52) U.S. Cl. CPC H04N 5/23254
USPC 348/208.6

(57) ABSTRACT

An image sensing apparatus has an image sensor which outputs, according to a subject, a first image signal in which each pixel is assigned color information of one color; a shake detection portion which detects a translational shake that causes the subject to translate on a moving image based on the output signal of the image sensor and a rotational shake that causes the subject to rotate; and a shake correction portion which corrects, based on the result of detection by the shake detection portion, the translational and rotational shakes contained in the first image signal. The shake correction portion first corrects the translational shake contained in the first image signal, then converts the first image signal into a second image signal in which each pixel is assigned color information of a plurality of colors, and then corrects the rotational shake contained in the second image signal.

### CROSS-REFERENCE TO RELATED APPLICATIONS

This nonprovisional application claims priority under 35 U.S.C. §119(a) on Patent Application No. 2011-288128 filed in Japan on Dec. 28, 2011, the entire contents of which are hereby incorporated by reference.

### BACKGROUND OF THE INVENTION

1. Field of the Invention

The present invention relates to image sensing apparatuses.

2. Description of Related Art

A shake that acts upon an image sensing apparatus may contain a translational shake which is composed of shakes in the yaw and pitch directions and a rotational shake which is a shake in the roll direction. Methods of electronically correcting the translational and rotational shakes contained in a moving image are known. Correction of a translational shake alone can be generally achieved by first storing an image signal corresponding to one frame in a DRAM (dynamic random access memory), then transferring the image signal a predetermined number of lines at a time to a line memory by raster scanning to correct the translational shake, and then returning the corrected image signal to the DRAM. An attempt to correct by this method the rotational shake as well requires securing a large amount of line memory depending on the rotation angle. As a simple example, suppose that a rotational shake of 45 degrees has occurred to a line extending over 100 pixels in the horizontal direction. The image signal of that line is then distributed over (100×√2) pixels in the vertical direction. Performing rotational shake correction on the line requires the use of line memory corresponding to (100×√2) lines. Since the line memory is often provided as SRAM (static random access memory) within an integrated circuit, an increased capacity of line memory naturally leads to higher cost of the integrated circuit etc.

For this reason, in rotation correction for coping with a rotational shake, an image signal is generally processed block by block. For example, by dividing the above-mentioned line into 10 equal parts in the horizontal direction and performing rotation correction processing block by block, it is possible to significantly suppress the capacity of memory needed. On the other hand, in a case where such block-by-block rotation correction is performed on a RAW image obtained from an image sensor having a Bayer array, signal processing requires a comparatively large overhead. This is the reason that rotation correction is generally performed at the stage of a YUV signal.

FIG. 9 shows an example of a conventional method of correcting translational and rotational shakes for a moving image. With the method shown in FIG. 9, first a RAW image 901 is converted into a YUV image 902 represented by a YUV signal, then a cut-out frame 903 located at a position corresponding to the amount of translational shake and having an inclination corresponding to the rotational shake angle is set in the YUV image 902, and rotation correction is performed on the image within the cut-out frame 903 in order to obtain a shake-corrected image 904. As will be understood from FIG. 9, the YUV image 902 used in the correction has an overhead for correction (the part that remains when the image within the cut-out frame 903 is removed from the entire YUV image 902) added to it, and thus the image size of the YUV image 902 is significantly larger than the shake-corrected image 904 that is actually recorded or otherwise treated.

The larger the image size of the YUV image used in the correction (in the example shown in FIG. 9, the YUV image 902), the heavier the processing burden on the signal processing blocks that handle the YUV signal (for example, the signal processing block that generates the YUV signal). Under the condition that the frame rate of the moving image and the image size of the individual frame images are constant, as the processing burden increases, the processing speed in those signal processing blocks needs to be increased. Needless to say, an increased processing speed is disadvantageous to reduction of electric power consumption.

### SUMMARY OF THE INVENTION

According to the present invention, an image sensing apparatus is provided with: an image sensor which outputs, according to a subject, a first image signal in which each pixel is assigned color information of one color; a shake detection portion which detects, based on the output signal of the image sensor or based on the result of detection by a sensor that detects movement of the image sensing apparatus, a translational shake that causes the subject to translate on a moving image based on the output signal of the image sensor and a rotational shake that causes the subject to rotate on the moving image; and a shake correction portion which corrects, based on the result of detection by the shake detection portion, the translational and rotational shakes contained in the first image signal. The shake correction portion first corrects the translational shake contained in the first image signal, then converts the first image signal into a second image signal in which each pixel is assigned color information of a plurality of colors, and then corrects the rotational shake contained in the second image signal.

### BRIEF DESCRIPTION OF THE DRAWINGS

FIG. 1 is a diagram schematically showing the external appearance of an image sensing apparatus embodying the invention along with a subject:

FIG. 2 is a configuration block diagram of the image sensing apparatus embodying the invention;

FIG. 3A is a diagram showing the relationship between a two-dimensional image and the X and Y axes, and FIG. 3B is a diagram showing the relationship among the X, Y, and Z axes;

FIG. 4 is a diagram showing an outline of shake correction processing embodying the invention;

FIGS. 5A to 5E are diagrams showing the composition of moving images;

FIG. 6 is a diagram showing an image sensing apparatus provided with a movement detection sensor;

FIG. 7 is a diagram showing the structure of movement detection information;

FIGS. 8A to 8C are diagrams illustrating the content of the X- and Y-axis movement information, rotation movement information, and Z-axis movement information which constitutes the movement detection information; and

FIG. 9 is a diagram showing an outline of conventional electronic shake correction processing for a moving image.

### DETAILED DESCRIPTION OF PREFERRED EMBODIMENTS

Examples of embodiment of the present invention will be described below specifically with reference to the accompanying drawings. Among the different drawings referred to in the course of description, the same parts are identified by the same reference signs, and in principle no overlapping description of the same parts will be repeated. In the present specification, for the sake of simple notation, symbols and signs representing different information, signals, physical quantities, states, members, etc. are occasionally used alone unaccompanied by the names of what they respectively stand for.

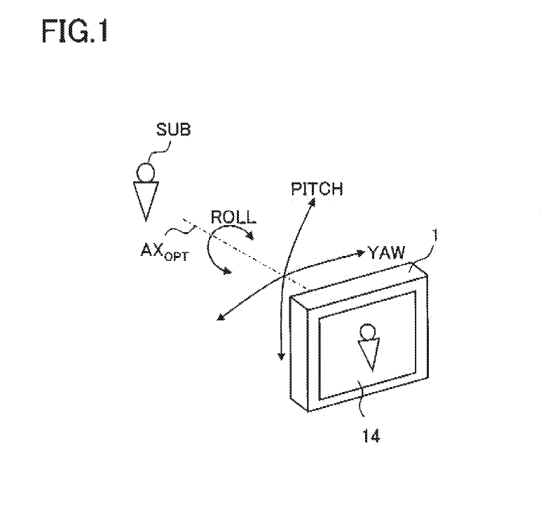

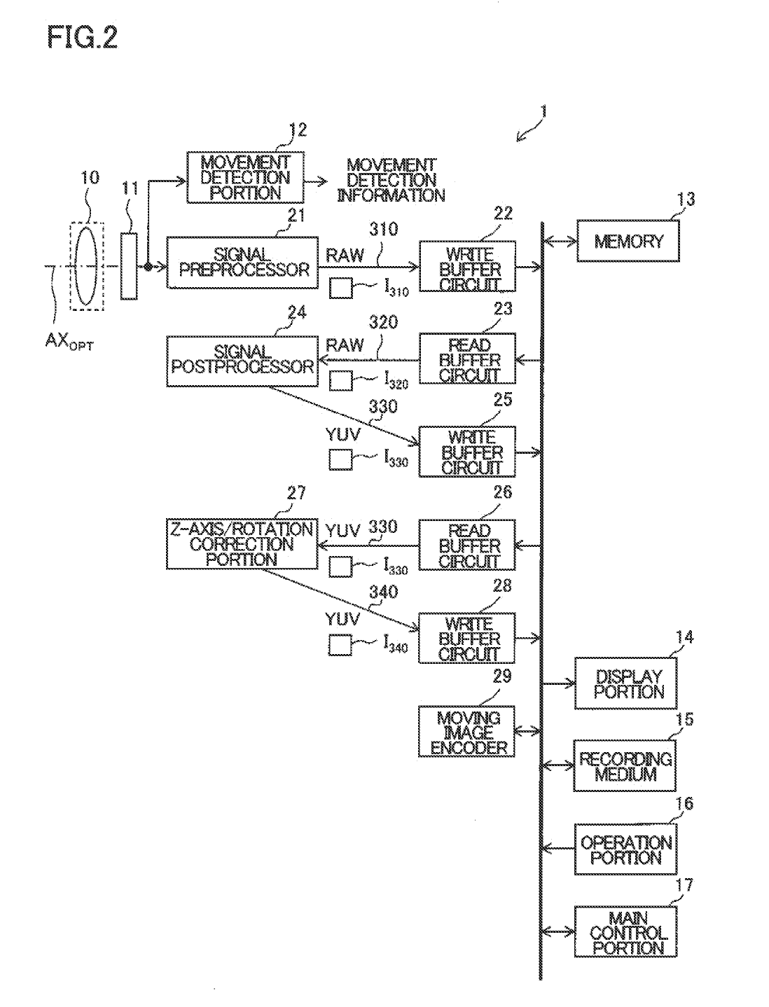

FIG. 1 schematically shows the external appearance of an image sensing apparatus 1 embodying the invention, along with a subject SUB being shot by the image sensing apparatus 1. In FIG. 1, taken as an example of the subject SUB is a single person. In practice, the subject SUB may comprise one or more arbitrary subjects. In this embodiment, for convenience' sake, it is assumed that the subject SUB is stationary in real space. FIG. 2 is a block diagram showing the configuration of the image sensing apparatus 1. The image sensing apparatus 1 includes portions referred to by the reference signs 10 to 17 and 21 to 29. The image sensing apparatus 1 is a digital video camera capable of shooting and recording moving images or a digital video camera capable of shooting and recording still images and moving images. The dash-and-dot line AX_{OPT} represents the optical axis of the image sensing apparatus 1 and of the optical system 10.

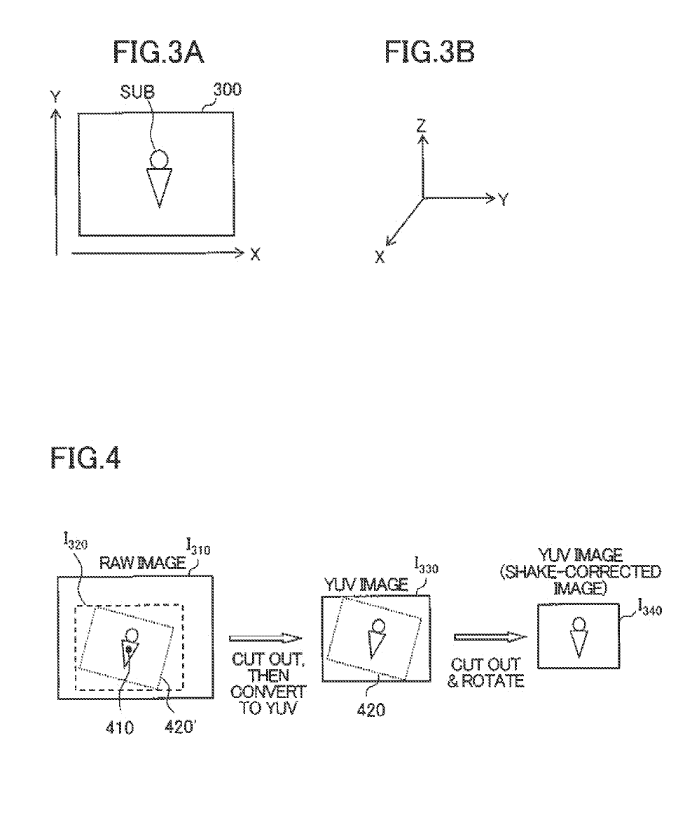

An image shot by the image sensing apparatus 1 by use of an image sensor 11 is displayed as a moving image on a display portion 14. The shooter (user) can perform various shooting operations while confirming what is being displayed on the display portion 14. While, for example, the shooter performs a shooting operation with the body of the image sensing apparatus 1 held in his hand or hands, the image sensing apparatus 1 may shake during the shooting of a moving image, causing the resulting moving image to contain blur. Such blur is also generally called camera shake. A shake of the image sensing apparatus 1 is synonymous with a movement of the image sensing apparatus 1. FIG. 3A shows a two-dimensional image 300 based on the output signal of the image sensor 11. The image signal of the two-dimensional image 300 contains the image signal of the subject SUB. The two-dimensional image 300 can be considered to be, for example, a kind of RAW image like the RAW image I₃₁₀ (see FIGS. 2 and 4) described later. The X and Y axes are axes that are parallel to the horizontal and vertical directions, respectively, of the two-dimensional image 300. As shown in FIG. 3B, the axis that is perpendicular to both the X and Y axes (that is, the axis that is perpendicular to the plane on which the two-dimensional image 300 is defined) is called the Z axis.

A shake of the image sensing apparatus 1 contains a shake in the yaw direction, that is, a shake in the horizontal direction; a shake in the pitch direction, that is, a shake in the vertical direction; and a shake in the roll direction, that is, a shake in the rotational direction. The shakes in the yaw and pitch directions cause the subject SUB to translate in the X and Y directions, respectively, on the two-dimensional image 300. Accordingly, a shake composed of shakes in the yaw and pitch directions can be called a translational shake. A shake in the roll direction causes the subject SUB to rotate on the two-dimensional image 300. Accordingly, a shake in the roll direction can be called a rotational shake. A shake of the image sensing apparatus 1 further contains a shake in the distance direction. A shake in the distance direction denotes a shake that increases or decreases the subject distance of the subject SUB. The subject distance of the subject SUB denotes the distance between the image sensing apparatus 1 and the subject SUB in real space. A shake in the distance direction causes the size of the subject SUB as observed on the two-dimensional image 300 to increase or decrease. Accordingly, a shake in the distance direction can be called an enlarging/reducing shake. In the following description, a shake in the distance direction is called a Z-axis shake.

The image sensing apparatus 1 corrects, by electronic shake correction, the translational, rotational, and Z-axis shakes contained in the output signal of the image sensor 11. Here, as shown in FIG. 4, first, at the stage of a RAW signal, the translational shake is corrected (from a RAW image I₃₁₀, a RAW image I₃₂₀ is cut out); then, the RAW signal is converted into a YUV signal (the RAW image I₃₂₀ is converted into a YUV image I₃₃₀); thereafter, at the stage of the YUV signal, the rotational and Z-axis shakes are corrected (from the YUV image I₃₃₀, a YUV image I₃₄₀ is generated). The processing shown in FIG. 4 will be described in detail later. A description will now be given of, as an example of the configuration for realizing such electronic shake correction, the configuration shown in FIG. 2.

The optical system 10 includes a plurality of lenses, an aperture stop, etc., and forms an optical image of the subject SUB on the image sensor 11. The image sensor 11 is a solid-state image sensor such as a CCD (charge-coupled device) image sensor or a CMOS (complementary metal oxide semiconductor) image sensor. The image sensor 11 performs photoelectric conversion on the optical image—representing the subject—incident on it through the optical system 10, and outputs the resulting electrical signal.

The memory 13 includes an SDRAM (synchronous dynamic random access memory) or the like, and temporarily stores various signals generated within the image sensing apparatus 1. The memory 13 may include, for example, a DDR SDRAM (double-data-rate synchronous dynamic random access memory). The display portion 14 includes a liquid crystal display panel or the like, and displays, under the control of a main control portion 17, an image shot by use of the image sensor 11, an image recorded on a recording medium 15, etc. The recording medium 15 is a non-volatile memory such as a card-form semiconductor memory, a magnetic disk, or the like, and stores, under the control of the main control portion 17, relevant signals and data. The operation portion 16 accepts various operations made by the user (operator) of the image sensing apparatus 1, and conveys how it is operated to the main control portion 17. The main control portion 17 includes a CPU (central processing unit) or the like, and controls, according to how the operation portion 16 is operated, the operation of different parts within the image sensing apparatus 1 in a concentrated fashion.

The signal preprocessor 21 subjects the signal—representing the subject SUB—output from the image sensor 11 to necessary signal processing (for example, correlated double sampling, automatic gain control, and A/D (analog-to-digital) conversion), and outputs the resulting signal as a RAW signal.

The output signal of the image sensor 11 is composed of the output signals of a plurality of light-receiving pixels provided on the image sensing surface of the image sensor 11. Between the image sensing surface of the image sensor 11 and the optical system 10, there are arranged, in a so-called Bayer array, color filters that transmit red light only, color filters that transmit green light only, and color filters that transmit blue light only. Consequently, the signal output from the image sensor 11 with respect to one pixel (one light-receiving pixel) has color information for one of red, green, and blue only. The same is true of the RAW signal. Specifically, the output signal of the image sensor 11 and the RAW signal are both a kind of image signal in which each pixel is assigned color information for one color only, and such an image signal can be called a source signal (first image signal), while an image represented by a source signal can be called a source image. The color filters may be arranged in any array other than a Bayer array.

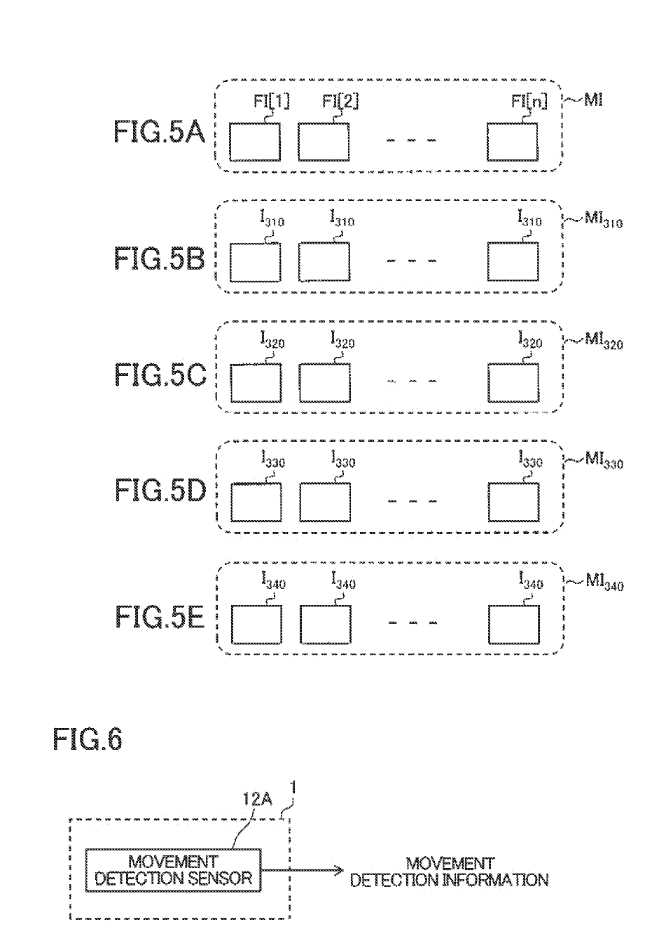

A two-dimensional image represented by a RAW signal is called a RAW image. The RAW signal output from the signal preprocessor 21 is referred to by the reference sign 310, and the RAW image represented by the RAW signal 310 is referred to by the reference sign I₃₁₀ (see FIG. 4 also). The image sensing apparatus 1 can, by performing shooting sequentially at predetermined frame periods by use of the image sensor 11, generate a moving image MI. As shown in FIG. 5A, the moving image MI is composed of a plurality of chronologically ordered frame images FI[1] to FI[n] (where n is an integer of 2 or more). A moving image MI that has a plurality of chronologically ordered RAW images I₃₁₀ as frame images FI[1] to FI[n] is called a moving image MI₃₁₀ (see FIG. 5B). The chronologically ordered RAW images I₃₁₀ are a plurality of RAW images I₃₁₀ obtained through shooting at mutually different time points (the same is true of the later-described RAW images I₃₂₀ and YUV images I₃₃₀ and I₃₄₀).

Translational, rotational, and Z-axis shakes can be considered to act upon the image sensing apparatus 1; or, seeing that a shake of the image sensing apparatus 1 produces blur in the moving image MI, a shake of the image sensing apparatus 1 can be considered to cause translational, rotational, and Z-axis shakes to mix in the output signal of the image sensor 11. Consider now a case where the output signal of the image sensor 11 contains translational, rotational, and Z-axis shakes. When a shakes is considered, the output signal of the image sensor 11 and the RAW signal 310 are equivalent. Accordingly, those translational, rotational, and Z-axis shakes remain as they are in the RAW signal 310 (that is, in the RAW images I₃₁₀). The translational shake contained in the RAW signal 310 causes the subject SUB to translate on the moving image MI₃₁₀, the rotational shake contained in the RAW signal 310 causes the subject SUB to rotate on the moving image MI₃₁₀, and the Z-axis shake contained in the RAW signal 310 causes the size of the subject SUB on the moving image MI₃₁₀ to increase or decrease.

Based on the output signal of the image sensor 11, the movement detection portion 12 detects the translational, rotational, and Z-axis shakes, and generates movement detection information that reflects the results of their detection. The movement detection portion 12 may instead detect the translational, rotational, and Z-axis shakes based on a signal obtained by subjecting the output signal of the image sensor 11 to predetermined signal processing. Methods for such detection are well-known, and therefore no detailed description in this respect will be given. For example, such detection is possible based on optical flows between frame images derived by a representative point matching method. The image sensing apparatus 1 may be provided with, instead of the movement detection portion 12, as shown in FIG. 6, a movement sensor that detects the movement of the image sensing apparatus 1 (such as an angular velocity sensor or an acceleration sensor), that is, a movement detection sensor 12A that detects translational, rotational, and Z-axis shakes acting upon the image sensing apparatus 1 so that based on the results of detection by the movement detection sensor 12A, movement detection information is generated. A movement detection portion 12 and a movement detection sensor 12A may be used together to generate movement detection information, for example in such a way that while the movement detection portion 12 detects a translational shake, the movement detection sensor 12A detects rotational and Z-axis shakes.

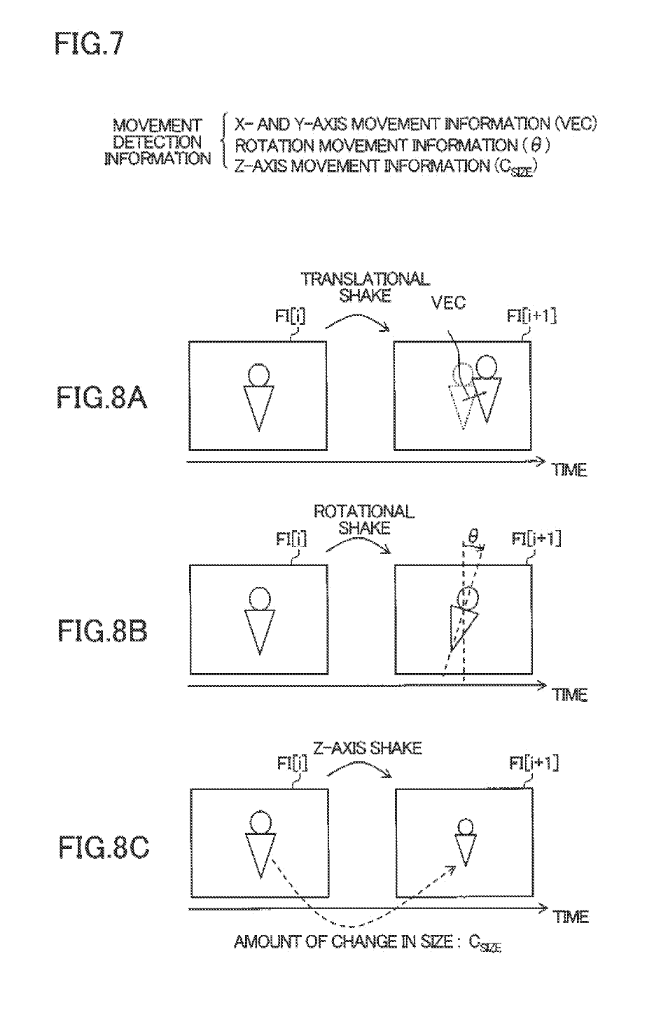

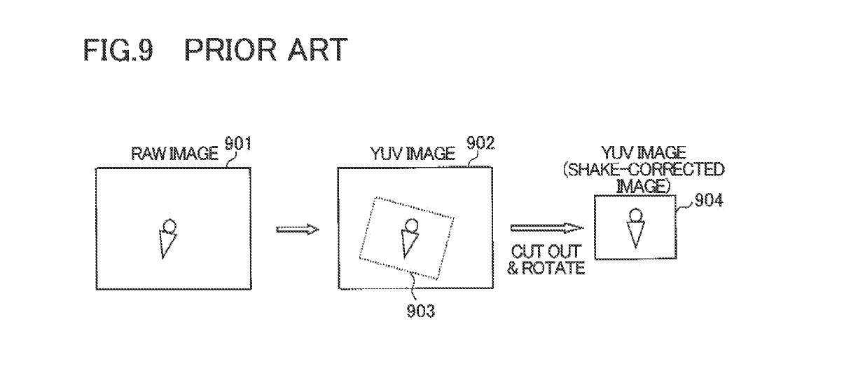

As shown in FIG. 7, the movement detection information contains X- and Y-axis movement information, rotation movement information, and Z-axis movement information. The X- and Y-axis movement information represents the displacement vector VEC of the position of the subject SUB (the translation component of the displacement of its position) between two chronologically consecutive frame images FI[i] and FI[i+1] (for example, between two RAW images I₃₁₀) (see FIG. 8A; i is an integer). The displacement vector VEC is composed of an X-axis component and a Y-axis component. The rotation movement information represents the angle θ of the rotation of the subject SUB between two chronologically consecutive frame images FI[i] and FI[i+1] (for example, between two RAW images I₃₁₀ (see FIG. 8B). The Z-axis movement information represents the amount of change C_{SIZE} in the size of the subject SUB between two chronologically consecutive frame images FI[i] and F[i+1] (for example, between two RAW images I₃₁₀ (see FIG. 8C). The displacement of the position of the subject SUB as represented by the X- and Y-axis movement information, the rotation of the subject SUB as represented by the rotation movement information, and the change in the size of the subject SUB as represented by the Z-axis movement information are brought about by translational, rotational, and Z-axis shakes respectively.

The write buffer circuit 22 in FIG. 2 writes the RAW signal 310 fed from the signal preprocessor 21 (that is, the image signal of the RAW images I₃₁₀) to the memory 13. The read buffer circuit 23 reads the RAW signal written to the memory 13 by the write buffer circuit 22, and outputs the read RAW signal to the signal postprocessor 24. Here, based on the movement detection information, the read buffer circuit 23 reads only part of the RAW signal 310 written to the memory 13, and outputs this part of the RAW signal 310 as a RAW signal 320. The RAW image represented by the RAW signal 320 is referred to by the reference sign I₃₂₀ (see FIG. 4 also). A moving image MI that has a plurality of chronologically ordered RAW images I₃₂₀ as frame images FI[1] to FI[n] is called a moving image MI₃₂₀ (see FIG. 5C).

Based on the X- and Y-axis movement information, the read buffer circuit 23 realizes cutting-out processing (translational shake correction processing) whereby part of the RAW signal 310 is cut out as the RAW signal 320 in such a way that the translational movement of the subject SUB on the moving image MI₃₁₀ (its movement in the X- and Y-axis directions resulting from a translational shake) is canceled on the moving image MI₃₂₀, that is, in such a way that the RAW signal 320 and the RAW images I₃₂₀ do not contain a translational shake Cutting out part of the RAW signal 310 as the RAW signal 320 is equivalent to cutting out part of the RAW images I₃₁₀ as the RAW images I₃₂₀. In practice, based on the displacement vector VEC (FIG. 8A) with respect to the current frame image as represented by the X- and Y-axis movement information, the read buffer circuit 23 adjusts the read start address on the memory 13 and thereby obtains the RAW signal 320. Since the RAW signal 320 has the translational shake eliminated, the RAW signal 320 can be said to be a RAW signal after translational shake correction (a source signal after translational shake correction).

In FIG. 4, the position 410 is the center position of the RAW images I₃₂₀ on the RAW images I₃₁₀. As a consequence of the read buffer circuit 23 changing the read start address, the center position 410 of the RAW images I₃₂₀ is changed, and thus the read buffer circuit 23 can be said to set, based on the X- and Y-axis movement information, the cut-out position (410) relative to which the RAW images I₃₂₀ (cut-out source image) is to be cut out from the RAW images I₃₁₀ (source image).

By well-known demosaicing processing, the signal postprocessor 24 converts the RAW signal 320 into a YUV signal 330 composed of a luminance signal Y and color difference signals U and V. In the process of this conversion, the signal postprocessor 24 may also perform other necessary signal processing (such as edge enhancement processing and noise reduction processing). An image represented by a YUV signal is called a YUV image, and the YUV image represented by the YUV signal 330 is referred to by the reference sign I₃₃₀ (see FIG. 4 also). A moving image MI that has a plurality of chronologically ordered YUV images I₃₃₀ as frame images FI[1] to FI[n] is called a moving image MI₃₃₀ (see FIG. 5D). A YUV signal is a kind of image signal in which each pixel is assigned color information of a plurality of colors. Accordingly, whereas each pixel of a RAW image is assigned color information of one of red, green, and blue alone, each pixel of a YUV image is assigned color information of a plurality of colors. That is, in a YUV image, the image signal corresponding to each pixel is composed of a luminance signal Y and two color difference signals U and V, and the luminance signal Y and the two color difference signals U and V contain color information of red, green, and blue.

The YUV signal 330 is written to the memory 13 by use of the write buffer circuit 25. Thereafter, the YUV signal 330 read from the memory 13 by use of the read buffer circuit 26 is fed to the Z-axis/rotational correction portion 27 (hereinafter referred to as the rotation correction portion 27). The rotation correction portion 27 subjects the YUV signal 330 to rotational shake correction processing and Z-axis shake correction processing, and thereby generates a YUV signal 340, which is a YUV signal having the rotational and Z-axis shakes eliminated. The YUV image represented by the YUV signal 340 is referred to by the reference sign I₃₄₀ (see FIG. 4 also). A moving image MI that has a plurality of chronologically ordered YUV images I₃₄₀ as frame images FI[1] to FI[n] is called a moving image MI₃₄₀ (see FIG. 5E). The write buffer circuit 28 can write the YUV signal 340 to the memory 13. The moving image MI₃₄₀ is displayed on the display portion 14; in addition, the image signal of the moving image MI₃₄₀ (that is, the YUV signal 340) is subjected to predetermined encoding processing in the moving image encoder 29 to generate stream data, which is then recorded on the recording medium 15.

As a result of the read buffer circuit 23 adjusting the read start address, the RAW signal 320 has the translational shake eliminated from it, and thus the YUV signal 330 contains no translational shake; however, the YUV signal 330 still contains the rotational and Z-axis shakes. Based on the rotation movement information, the rotation correction portion 27 performs rotational shake correction processing in such a way that the rotation of the subject SUB on the moving image MI₃₃₀ is canceled on the moving image MI₃₄₀, that is, in such a way that the YUV signal 340 and the YUV images I₃₄₀ do not contain a rotational shake. As described previously, in this embodiment, it is assumed that the subject SUB remains stationary in real space, and therefore the rotation of the subject SUB on the moving image MI₃₃₀ is a rotation resulting from a rotational shake. In practice, in the rotational shake correction processing, based on the rotation angle θ (see FIG. 8B) with respect to the current frame image as represented by the rotation movement information, the rotation correction portion 27 sets a cut-out frame 420 inclined at an angle of θ relative to the YUV images I₃₃₀ (see FIG. 4), performs geometric transformation including affine transformation whereby the image within the cut-out frame 420 on the YUV images I₃₃₀ is rotated by an angle of (−θ), and thereby generates the YUV images I₃₄₀. To keep the image size of the YUV images I₃₄₀ constant, the geometric transformation here may include resolution conversion processing (image size enlargement or reduction processing) that suits the size of the cut-out frame 420.

Based on the Z-axis movement information, the rotation correction portion 27 performs Z-axis shake correction processing in such a way that the increase or decrease in the size of the subject SUB on the moving image MI₃₃₀ is canceled on the moving image MI₃₄₀, that is, the YUV signal 340 and the YUV images I₃₄₀ do not contain a Z-axis shake As described previously, in this embodiment, it is assumed that the subject SUB remains stationary in real space, and therefore a change in the size of the subject SUB on the moving image MI₃₃₀ results from a Z-axis shake. Specifically, based on the amount of change C_{SIZE} (FIG. 8C) with respect to the current frame image as represented by the Z-axis movement information, the rotation correction portion 27 changes the size of the cut-out frame 420 and thereby realizes the above-mentioned Z-axis shake correction processing. Here, to keep the image size of the YUV images I₃₄₀ constant, the rotation correction portion 27 subjects the image in the cut-out frame 420 to resolution conversion processing (image size enlargement or reduction processing) that suits the size of the cut-out frame 420. In practice, the resolution conversion processing here may be incorporated in the above-mentioned geometric transformation in the rotational shake correction processing. Through the rotational shake correction processing and the Z-axis shake correction processing described above, the YUV signal 340 becomes an image signal that has the translational, rotational, and Z-axis shakes eliminated.

In electronic shake correction, it is preferable to keep the angle of view of the ultimate shake-corrected images (in this embodiment, the YUV images I₃₄₀) constant. On the other hand, in a case where the output signal of the image sensor 11 contains a rotational shake, in the rotational shake correction processing, according to the rotation angle θ, only part of the YUV images I₃₃₀ is cut out as the YUV images I₃₄₀. Under the condition that the angle of view of the YUV images I₃₃₀ remains constant, as the absolute value of the rotation angle θ increases, the angle of view of the YUV images I₃₄₀ decreases. Thus, to keep the angle of view of the ultimate shake-corrected images constant, it is preferable that the read buffer circuit 23, when generating the RAW images I₃₂₀ (cut-out source images), optimally set and change the image size of the RAW images I₃₂₀ based on the rotation movement information. Through the setting and change here, for example, the image size of the RAW images I₃₂₀ is at its minimum when the rotation angle θ equals zero and increases as the absolute value of the rotation angle θ increases from zero.

In a case where the output signal of the image sensor 11 contains a Z-axis shake, as compared with in a case where the output signal of the image sensor 11 contains no Z-axis shake, it is necessary to change the size of the cut-out frame 420. Accordingly, to keep the angle of view of the ultimate shake-corrected images constant, it is preferable that the read buffer circuit 23, when generating the RAW images I₃₂₀ (cut-out source images), set and change the image size of the RAW images I₃₂₀ based on the rotation movement information and the Z-axis movement information. It is preferable that the read buffer circuit 23 set and change the image size of the RAW images I₃₂₀ based on the rotation movement information and the Z-axis movement information so as to minimize the image size of the RAW images I₃₂₀ while fulfilling the condition that the angle of view of the YUV images I₃₄₀ is kept constant. The rectangular frame 420′ in FIG. 4 is a frame that is assumed to be corresponding to the cut-out frame 420 in that setting.

As described above, in this embodiment, at the stage of a RAW signal, a translational shake is corrected; then the RAW signal is converted into a YUV signal; and thereafter a rotational shake and a Z-axis shake are corrected. Thus, first the amount of data is reduced through correction of a translational shake and then conversion into a YUV signal is performed. This helps reduce the processing burden on the signal processing blocks (including the signal postprocessor 24) that handle the YUV signal. This leads to a reduction in the required processing speed and a reduction in electric power consumption.

The image sensing apparatus 1 can be considered to be provided with a shake detection portion which detects a translational shake, a rotational shake, and a Z-axis shake, and a shake correction portion (shake correcting device) which performs, according to the results of the detection by the shake detection portion, translational shake correction processing, rotational shake correction processing, and Z-axis shake correction processing. The image processing device provided in the image sensing apparatus 1 includes the shake correction portion as one of its components, and may further include the shake detection portion as another. The movement detection portion 12 in FIG. 2 and the movement detection sensor 12A in FIG. 6 are a kind of shake detection portion. The shake correction portion is provided with the blocks refereed to by the reference signs 23 to 28, and may be further provided with the signal preprocessor 21 and the write buffer circuit 22. The image processing device is provided with the blocks referred to by the reference signs 21 to 28, and may be further provided with the movement detection portion 12 and a moving image encoder 29. The image processing device can be formed as an integrated circuit, and the memory 13 can be considered to be an external memory for the integrated circuit.

The shake correction portion can be said to be provided with a first correction portion which, based on the results of detection by the shake detection portion (movement detection information), cuts out part of the RAW signal 310 (RAW images I₃₁₀) and thereby corrects the translational shake, a signal conversion portion which converts the RAW signal 320, which is a RAW signal after translational shake correction, into the YUV signal 330, and a second correction portion which performs the above-described rotational shake correction processing based on the result of detection of the rotational shake and thereby generates the YUV signal 340 having the translational and rotational shakes corrected. The second correction portion may further perform the above-described Z-axis shake correction processing. In the configuration shown in FIG. 2, the read buffer circuit 23, the signal postprocessor 24, and the rotation correction portion 27 function as the first correction portion, the signal conversion portion, and the second correction portion, respectively. By performing first the cutting-out by the first correction portion and then the conversion into the YUV signal, it is possible to reduce the processing burden on the signal processing blocks (including the signal postprocessor 24) that handle the YUV signal.

The first correction portion can, according to the results of detection of the rotational shake, set and change the image size of the RAW image (RAW image I₃₂₀) to be cut out from the RAW image (RAW image I₃₁₀) before translational shake correction, and the setting and the change here can be performed according to the results of detection of the rotational and Z-axis shakes. In this way, it is possible to suppress the image size of the RAW image (RAW image I₃₂₀) cut out through the translational shake correction processing to a comparatively small image size (preferably, the minimum required image size), and this makes it possible to reduce the processing burden on the signal processing blocks (including the signal postprocessor 24) that handle the YUV signal.

Modifications and Variations

The present invention may be implemented with any modifications and variations made within the scope of the technical concept defined in the appended claims. The embodiment specifically described above is merely an example of how the invention can be implemented, and the significances of the terms used to describe the invention and its features are not meant to be limited to those in the embodiment described above. The specific values mentioned in the above description are merely examples, and can naturally be modified to any different values. Notes that apply to the embodiment described above are given below as Notes 1 to 5. Features from different notes may be combined together unless incompatible.

Note 1: The image sensing apparatus 1 may be capable of so-called electronic zooming In electronic zooming, the necessary signal processing may be performed simultaneously with the signal processing in the signal postprocessor 24, or may be performed simultaneously with the Z-axis shake correction processing.

Note 2: Although, in the embodiment described above, not only the translational and rotational shakes but also the Z-axis shake is corrected, the detection and correction of the Z-axis shake may be omitted.

Note 3: Although, in the embodiment described above, a YUV signal is taken as an example of an image signal in which each pixel is assigned color information of a plurality of colors, an image signal in which each pixel is assigned color information of a plurality of colors may instead by any image signal other than a YUV signal.

Note 4: Although not shown in FIG. 2, the image sensing apparatus 1 may be further provided with a microphone and a sound signal processing portion which generate a sound signal representing the ambient sound around the image sensing apparatus 1, and the data of such a sound signal may be recorded along with the data of a moving image on the recording medium 15.

Note 5: The image sensing apparatus 1 may be one that is incorporated in any appliance (for example, a portable terminal such as a cellular telephone).

What is claimed is:

1. An image sensing apparatus comprising:
an image sensor which outputs, according to a subject, a first image signal in which each pixel is assigned color information of one color;
a shake detection portion which detects, based on an output signal of the image sensor or based on a result of detection by a sensor that detects movement of the image sensing apparatus, a translational shake that causes the subject to translate on a moving image based on the output signal of the image sensor and a rotational shake that causes the subject to rotate on the moving image; and
a shake correction portion which corrects, based on a result of detection by the shake detection portion, the translational and rotational shakes contained in the first image signal,
wherein
the shake correction portion first corrects the translational shake contained in the first image signal, then converts the first image signal into a second image signal in which each pixel is assigned color information of a plurality of colors, and then corrects the rotational shake contained in the second image signal.

2. The image sensing apparatus according to claim 1, wherein
the shake correction portion comprises:
a first correction portion which cuts out, based on the result of the detection by the shake detection portion, part of the first image signal and thereby corrects the translational shake;
a signal conversion portion which converts the first image signal after correction of the translational shake into the second image signal; and
a second correction portion which applies, based on a result of detection of the rotational shake, geometric transformation including a rotation component to part of the second image signal and thereby generates an output image signal which has the translational and rotational shakes corrected.

3. The image sensing apparatus according to claim 2, wherein
the first correction portion cuts out part of a source image which is represented by the first image signal before correction of the translational shake and thereby generates a cut-out source image which is an image of the first image signal after correction of the translational shake, and
when generating the cut-out source image, the first correction portion sets, based on a result of detection of the translational shake, a cut-out position of the cut-out source image on the source image and sets, based on the result of the detection of the rotational shake, an image size of the cut-out source image.

4. The image sensing apparatus according to claim 1, wherein
the shake detection portion also detects, based on the output signal of the image sensor or based on the result of the detection by the sensor, an enlarging/reducing shake that causes a size of the subject on the moving image to increase or decrease, and
the shake correction portion also corrects, based on the result of the detection by the shake detection portion, the enlarging/reducing shake contained in the first image signal.
